(19) United States
(12) Patent Application Publication
(10) Pub. No.: US 2012/0283057 A1
(43) Pub. Date: Nov. 8, 2012

(54) AUTOMATIC TRANSMISSION FOR A BICYCLE

(76) Inventors: Chang-Yong Lee, Gyeonggi-do (KR); Jung-Uk Park, Busan (KR); Kyung-Il Jung, Seoul (KR)

(21) Appl. No.: 13/519,238

(22) PCT Filed: Dec. 27, 2010
(86) PCT No.: PCT/KR2010/009347

§ 371 Date: Jun. 26, 2012

(30) Foreign Application Priority Data
Dec. 28, 2009 (KR) 10-2009-0131977

(51) Int. Cl. F16H 9/24

(52) U.S. Cl. 474/81

(57) ABSTRACT

The present invention relates to an automatic transmission for a bicycle, including: a front sprocket unit coupled to pedals; a rear sprocket unit mounted to a rear wheel; and a drive chain, extremities of which are wound around one sprocket of the front sprocket unit and around one sprocket of the rear sprocket unit, respectively, whereby the torque and speed of the bicycle can be changed in accordance with the combination of the diameters of the sprockets. The front sprocket unit receives a rotating force, and rotates in a direction that propels a bicycle body having pedals forward, but does not receive a rotating force in a direction opposite the rotating direction. The automatic transmission of the present invention can automatically perform a gear-shifting operation without forcing a rider to work the pedals while riding, yet changing the torque and speed of the bicycle.

### TECHNICAL FIELD

The present invention relates generally to an automatic transmission thr a bicycle and, more particularly, to an automatic transmission for a bicycle which can perform an automatic gear-shifting operation without forcing a rider to pedal the bicycle while riding.

### BACKGROUND ART

Generally, bicycles are used for a variety of purposes, such as leisure, sports and as a substitute means of transportation.

Particularly, there has been an increased use of bicycles in recent years because of an increased number of persons who go to the office and go home from the office on bicycles and an increase in the number of parks in which bicycles can be ridden and the number of bicycle paths in response to the environmental improvement of residential streets.

Bicycles are typically equipped with a transmission that is used to select a transmission gear ratio appropriate to riding conditions, such as road conditions and the moving speed of the bicycle, thereby allowing the bicycle to efficiently move according to the riding conditions.

A conventional transmission for a bicycle includes: a front sprocket unit that is formed by assembling a plurality of sprockets, diameters of which gradually become reduced going from the outside to the inside along a drive shaft that is connected to pedal cranks;

a rear sprocket unit that is formed by assembling a plurality of sprockets, diameters of which gradually become reduced going from the inside to the outside of a rear wheel hub;

a drive chain, one of the two extremities of which is wound around one sprocket of the front sprocket unit and another extremity of which is wound around one sprocket of the rear sprocket unit;

a front derailleur that is placed at a predetermined location around a front wheel of the bicycle and shifts the drive chain to one sprocket of the front sprocket unit;

a rear derailleur that is placed at a location around a rear wheel of the bicycle and shifts the drive chain to one sprocket of the rear sprocket unit;

two grip shifters that are placed on opposite handlebars of the bicycle and actuate the front derailleur and the rear derailleur, respectively; and

cables that connect one of the two grip shifters to the front derailleur and connect the other grip shifter to the rear derailleur, respectively.

When a rider pedals the bicycle and rotates the front sprocket unit, the rotating force of the front sprocket unit is transmitted to the rear sprocket unit by the drive chain, thereby rotating the rear wheel and moving the bicycle forwards. When the rider manipulates the grip shifters while riding, the cables are pulled or released, thereby actuating the front derailleur and the rear derailleur and causing the drive chain to be wound around one sprocket of the front sprocket unit and one sprocket of the rear sprocket unit and, accordingly, performing a gear-shifting operation so as to change the torque and speed of the bicycle such that the torque and speed are compatible with riding conditions.

Here, to perform the gear-shifting operation of the bicycle, it is necessary for the rider to rotate the front sprocket unit by working the pedals.

### Disclosure

### Technical Problem

The conventional transmission for a bicycle is configured in such a way that when a rider does not work the pedals while riding the bicycle, neither of the front or rear sprocket units rotates, but only the rear wheel rotates by frictional contact with a road surface, so that, to perform a gear-shifting operation of the bicycle, the rider must pedal the bicycle and this inconveniences the rider.

Accordingly, the present invention has been made keeping in mind the above problems occurring in the prior art, and an object of the present invention is to provide an automatic transmission for a bicycle, which can automatically perform a gear-shifting operation without forcing a rider to pedal the bicycle while riding, thereby realizing improved manipulation performance of the transmission when performing the gear-shifting operation of the bicycle.

### Technical Solution

in order to accomplish the above object, the present invention provides an automatic transmission for a bicycle, including: a front sprocket unit coupled to a drive shaft of pedals of a bicycle body and rotating by a rotating force of the pedals, the front sprocket unit being formed by assembling a plurality of sprockets having different diameters;

a rear sprocket unit mounted to a rear wheel of the bicycle body and formed by assembling a plurality of sprockets having different diameters;

a drive chain, extremities of which are wound around one sprocket of the front sprocket unit and one sprocket of the rear sprocket unit, respectively; and

a drive chain shifter shifting one of the extremities of the drive chain to one sprocket of the front sprocket unit so as to allow the one extremity of the chain to be wound around the sprocket of the front sprocket unit and shifting the other extremity of the drive chain to one of the rear sprocket unit so as to allow the other extremity of the chain to be wound around the sprocket of the rear sprocket unit,

wherein the front sprocket unit is coupled to the drive shaft of the pedals in such a way that the front sprocket unit can rotate by a rotating force of the pedals when the pedals rotate in a rotating direction which propels the bicycle body forwards, but the drive shaft of the pedals can overrun when the pedals rotate in a direction opposite to the rotating direction.

The drive chain shifter may include: a front derailleur shifting the one extremity of the drive chain to one sprocket of the front sprocket unit so as to allow the extremity of the chain to be wound around the sprocket of the front sprocket unit; a rear derailleur shifting the other extremity of the drive chain to one sprocket of the rear sprocket unit so as to allow the extremity of the chain to be wound around the sprocket of the rear sprocket unit; a derailleur actuator actuating the front derailleur and the rear derailleur; and a derailleur controller controlling an operation of the derailleur actuator so as to realize an appropriate transmission gear ratio suitable to riding conditions of the bicycle.

The drive chain shifter may include: a speed sensor for sensing a speed of the bicycle and an angle sensor for sensing a gradient of a road.

The drive chain shifter may further include: a position sensor for sensing a position of the drive chain and applying sensing results to the derailleur controller.

The derailleur actuator may include: an actuating cable connected to the front derailleur and the rear derailleur; a rack gear connected to the actuating cable; a pinion gear rotatably engaged with the rack gear; and a worm engaged with the pinion gear and rotating in opposite directions by a motor.

The front sprocket unit may include the drive shaft connected to the pedals and a shaft hole receiving the drive shaft therein, wherein the transmission may further inclue: a unidirectional bearing interposed between the drive shaft and the shaft hole so that the unidirectional bearing can allow the front sprocket unit to rotate synchro with the pedals when the pedals rotate in the rotating direction propelling the bicycle body forwards, but does not transmit the rotating force of the pedals to the front sprocket unit when the pedals rotate in the direction opposite to the rotating direction, wherein the unidirectional bearing may include: an outer race integrated with the front sprocket unit; an inner race integrated with the drive shaft of the pedals; rollers placed between the outer race and the inner race; and an outer race checking unit that allows the outer race to rotate synchro with the inner race when the inner race rotates in a rotating direction which propels the bicycle body forwards, and allows the inner race to overrun with the outer race which does not rotate when the inner race rotates in a direction opposite to the rotating direction.

The outer race checking unit may include: roller strop protrusions protruding from an outer circumferential surface of the inner race at spaced locations and stopping the respective rollers in the direction opposite to the rotating direction which propels the bicycle body forwards; checking pins movably connected to the respective roller stop protrusions and pushing the respective rollers in the rotating direction which propels the bicycle body forwards; and springs placed in the respective roller stop protrusions and elastically biasing the respective checking pins.

### Advantageous Effects

As described above, the present invention can perform a gear-shifting operation of a bicycle without forcing a rider to pedal the bicycle while riding, thereby bringing the rider convenience, and can prevent a drive chain from being removed from sprockets even when the rider does not pedal the bicycle while performing the gear-shifting operation.

The present invention can perform a stable and effective gear-shifting operation when it is required to automatically change the torque and speed of the bicycle, and can prevent the drive chain from being removed from sprockets even when the rider does not pedal the bicycle while performing the automatic gear-shifting operation,

Therefore, the present invention can allow the rider to more easily and efficiently manipulate the transmission when performing the gear-shifting operation of the bicycle and can ensure safety of the rider.

### DESCRIPTION OF DRAWINGS

FIG. 1 is a schematic view illustrating the construction of an automatic transmission for a bicycle according to the present invention;

FIG. 2 is a schematic view illustrating important parts of the automatic transmission according to the present invention;

FIG. 3 is an exploded perspective view illustrating the construction of an embodiment of the present invention;

FIG. 4 is a sectional view illustrating the construction of a unidirectional bearing of the present invention;

FIG. 5 is a perspective view illustrating another embodiment of the present invention; and

FIG. 6 is a side view illustrating a bicycle equipped with the automatic transmission of the present invention.

* Description of reference numbers of important parts *

| | |
|---|---|
| 1: bicycle body | 2: pedal |
| 10: front sprocket unit | 20: rear sprocket unit |
| 30: drive chain | 40: drive chain shifter |
| 41: front derailleur | 42: rear derailleur |
| 43: derailleur actuator | 44: derailleur controller |
| 45: speed sensor | 46: angle sensor |

### BEST MODE

Preferred embodiments of the present invention will be described in detail with reference to the accompanying drawings hereinbelow,

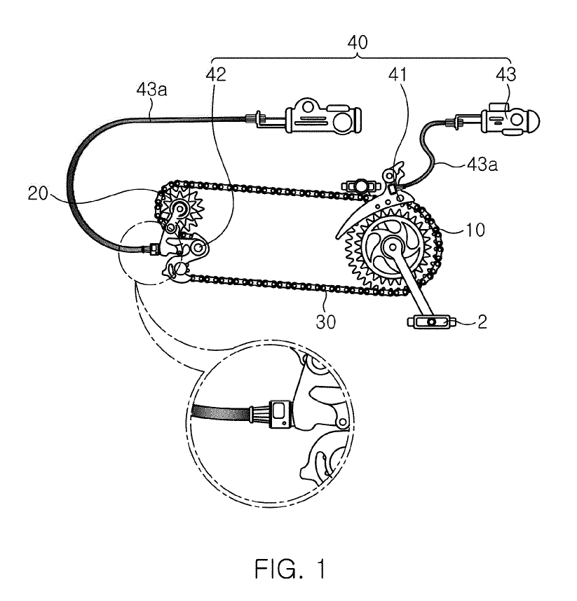

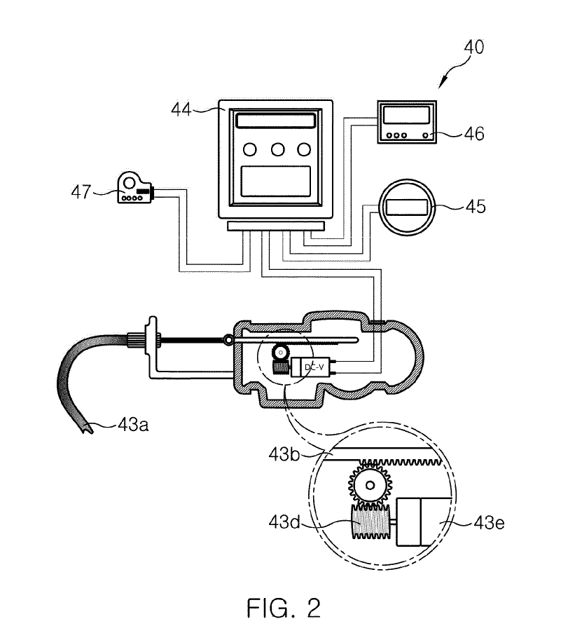

As shown in FIG. 1, an automatic transmission for a bicycle according to the present invention includes a front sprocket unit 10 that is connected to pedals 2 of a bicycle body 1.

The front sprocket unit 10 is formed by assembling a plurality of sprockets, which have different diameters and are assembled in such a way that the diameters of the sprockets gradually become reduced going from the outside to the inside along a drive shaft. Here, the drive shaft is connected to the cranks that are coupled to respective pedals 2.

Further, a rear sprocket unit 20 is mounted to a rear wheel 4 of the bicycle body 1 and is coupled to the front sprocket unit 10 by a drive chain 30, thereby receiving a rotating force from the front sprocket unit 10.

The rear sprocket unit 20 is formed by assembling a plurality of sprockets, which have different diameters and are assembled in such a way that the diameters of the sprockets gradually become reduced going from the inside to the outside of the hub of the rear wheel 4.

Accordingly, when a rider works the pedals 2 and rotates the front sprocket unit 10, the rotating force of the front sprocket unit 10 is transmitted to the rear sprocket unit 20 by the drive chain 30, so that the rear wheel 4 can rotate.

Here, changing the torque and speed of the bicycle can be realized by a combination of diameters of sprockets of the front units 10 and rear sprocket units 20, to which the drive chain 30 has been shifted by a gear-shifting operation.

Further, the number of gear-shifting stages of the bicycle is determined by multiplying the number of sprockets of the front sprocket unit 10 by the number of sprockets of the rear sprocket unit 20.

For example, when the front sprocket unit 10 includes three sprockets having different diameters and the rear sprocket unit 20 includes seven sprockets having different diameters, twenty one gear-shifting stages can be realized.

Further, when the drive chain 30 is wound around sprockets of the front and rear sprocket units 10 and 20, which have the same diameter, the rear sprocket unit 20 rotates one time for every one rotation of the front sprocket unit 10.

Here, when the rear sprocket unit 20 rotates in response to the rotation of the front sprocket unit 10, the number of rotations of the rear sprocket unit 20 is determined by a diameter ratio between the chained sprockets of the front and rear sprocket units 10 and 20, around which the drive chain is wound.

For example, when the diameter of the chained sprocket of the front sprocket unit 10 is 44 cm and the diameter of the chained sprocket of the rear sprocket unit 20 is 11 cm, the rear sprocket unit 20 rotates four times thr every one rotation of the front sprocket unit 10.

However, when the drive chain 30 is wound around sprockets of the first and second sprocket units, in which the diameter of the chained sprocket of the front sprocket unit 10 is 22 cm and the diameter of the chained sprocket of the rear sprocket unit 20 is 34 cm, the rear sprocket unit 20 rotates 0.65 time for every one rotation of the front sprocket unit 10.

Here, the torque and the moving distance of the bicycle are proportional to each other under the same condition, so that when the moving distance is reduced in a state in which the torque remains unchanged, the rider can save energy,

in other words, when one sprocket of the front sprocket unit having a larger diameter and one sprocket of the rear sprocket unit having a smaller diameter are coupled to each other by the drive chain, every single rotation of the pedals 2 can move the bicycle by a further distance, so that such a coupling of the sprockets is preferable when it is required to increase the speed of the bicycle on a level road.

However, when one sprocket of the front sprocket unit having a smaller diameter and one sprocket of the rear sprocket unit having a lamer diameter are coupled to each other, the rider can save enemy while pedaling the bicycle so that such a coupling of the sprockets is preferable when riding up a hill.

Accordingly, the rider can easily ride the bicycle along a hill or a level road while selecting the appropriate gear-shifting stages of the bicycle according to riding conditions using the above-mentioned theory.

In the present invention, the drive chain 30 is shifted by a drive chain shifter 40 that shifts one of the two extremities of the drive chain 30 to one sprocket of the front sprocket unit 10 and shifts another extremity of the drive chain 30 to one sprocket of the rear sprocket unit 20, thereby allowing the drive chain 30 to be wound around the sprockets.

The drive chain shifter 40 includes: a front derailleur 41 that shifts one of the two extremities of the drive chain 30 to one sprocket of the front sprocket unit 10;

a rear derailleur 42 that shifts the other extremity of the drive chain 30 to one sprocket of the rear sprocket unit 20;

derailleur actuators 43 that actuate the front derailleur 41 and the rear derailleur 42, respectively; and

a derailleur controller 44 that controls the operation of the derailleur actuators 43 so as to realize an appropriate transmission gear ratio suitable to riding conditions of the bicycle body 1.

The drive chain shifter 40 includes a speed sensor 45 that is connected to the derailleur controller 44 and senses the speed of the bicycle body 1, and an angle sensor 46 that is connected to the derailleur controller 44 and senses the gradient of a road and applies the sensing results to the derailleur controller 44 an that the drive chain shifter 40 can realize an appropriate gear-shifting stage by shifting the drive chain 30 according to both the moving conditions of the bicycle body 1 and the road conditions, such as the gradient of the road.

Further, it is preferred that the drive chain shifter 40 include a position sensor 47, which is mounted to each of the front derailleur 41 and the rear derailleur 42 and is connected to the derailleur controller 44 and senses the position of the drive chain 30, and applies the sensing results to the derailleur controller 44.

When the drive chain 30 is shifted to one sprocket so as to realize an appropriate gear-shifting stage, the position sensor 47 senses a shifted position of the drive chain and applies information of the shifted position of the chain to the derailleur controller 44, thereby realizing a precise gear-shifting operation.

Each of the derailleur actuators 43 includes: an actuating cable 43a that is connected to an associated one of the front derailleur 41 and the rear derailleur 12;

a rack gear 43b that is connected to the actuating cable 43a;

a pinion gear 43c that is rotatably engaged with the rack gear 43b; and

a worm 43d that is engaged with the pinion gear 43c and rotates in opposite directions by a motor 43e.

In the derailleur actuator 43, the rotating force of the worm 43d that is rotated by the motor 43e is transmitted to the pinion gear 43c, so that the pinion gear 43c is rotated and the rack gear 43b is moved to the left or right by the pinion gear, thereby pulling and releasing the actuating cable 43a.

The front derailleur 41 or the rear derailleur 42 is automatically actuated by an associated actuating cable 43a and shifts the drive chain 30 to a desired sprocket, thereby automatically realizing an appropriate gear-shifting stage suitable to the riding conditions.

When the front sprocket unit 10 or the rear sprocket unit 20 is rotated during the gear-shifting operation, the drive chain 30 is shifted to a desired sprocket and is easily wound around the sprocket, thereby realizing an appropriate gear-shifting stage.

Here, the front sprocket unit 10 of the present invention receives a forward rotating force of the pedals, which can move the bicycle body 1 forwards, thereby being rotated by the rotating force, but does not receive a reverse rotating force that is transmitted in a direction opposite to the forward rotating direction.

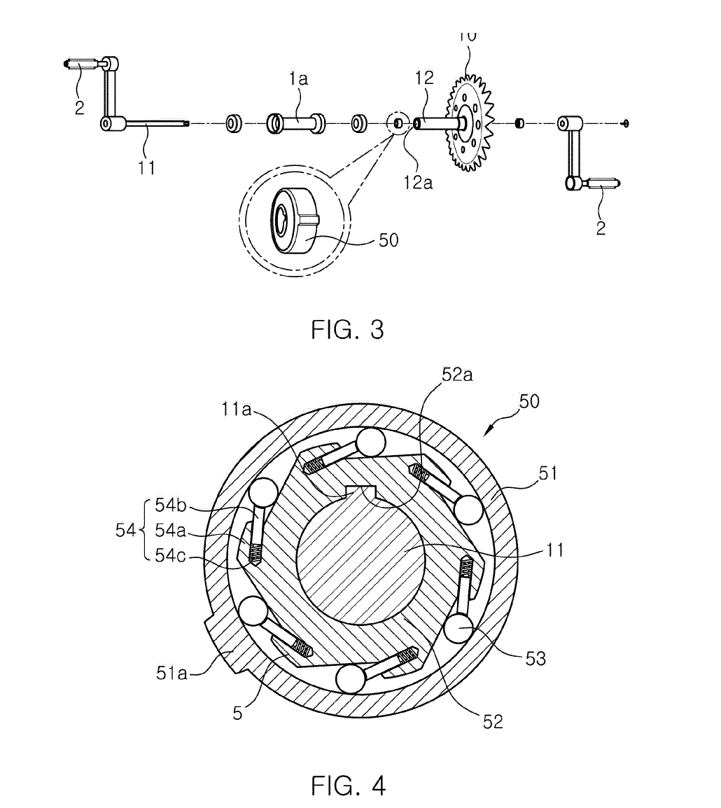

As shown in FIG. 3, the front sprocket unit 10 includes a drive shaft 11 and a shaft hole 12a. The drive shaft 11 is connected to the pedals 2 and the shaft hole 12a receives the drive shaft 11 therein, with a unidirectional bearing 50 interposed between the drive shaft 11 and the shaft hole 12a. Here, the unidirectional bearing 50 transmits a forward rotating force of the pedals 2, which can move the bicycle body 1 forwards, to the front sprocket unit 10 and allows the front sprocket unit 10 to be rotated together with the pedals 2. However, the unidirectional bearing 50 does not transmit a rotating force of the pedals, which is transmitted in a direction opposite to the forward rotating direction, to the front sprocket unit 10.

In other words, the drive shaft 11 of the pedals 2 is coupled to the front sprocket unit 10 in such a way that, when the pedals 2 are rotated in a direction in which the bicycle body 1 can move forwards, the drive shaft 11 of the pedals 2 rotates the front sprocket unit 10 in that direction and propels the bicycle body 1 forwards.

However, when the pedals 2 are rotated in a direction opposite to the forward rotating direction, the drive shaft 11 of the pedals 2 runs idle.

Described in detail, a sprocket shall 12 is provided on one side of the front sprocket unit 10. The sprocket shaft 12 is rotatably received in a pedal bushing 1a of the bicycle body 1 and has the shaft hole 12a therein. A double direction bearing is provided between the outer circumferential surface of the sprocket shaft 12 and the inner circumferential surface of the pedal bushing 1a and causes the sprocket shaft 12 to be easily rotated,

Here, the pedals 2 are connected to the drive shaft 11 that passes through the shaft hole 12a of the sprocket shaft 12. The unidirectional bearing 50 is installed in the sprocket shall 12 in a state in which that the bearing 50 is fitted over the drive shaft 11.

As shown in FIG. 4, the unidirectional bearing 50 includes: an outer race 51 that is integrated with the front sprocket unit;

an inner race 52 that is integrated with the drive shaft 11 of the pedals 2;

rollers 53 that are placed between the outer race 51 and the inner race 52; and

an outer race checking unit 54 that allows the outer race 51 to be rotated to together with the inner race 52 when the inner race 52 is rotated in a forward rotating direction which tends to propel the bicycle body 1 forwards, and allows the inner race 52 to overrun with the outer race 51 which does not rotate when the inner race 52 is rotated in a direction opposite to the forward rotating direction.

A locking protrusion 51a protrudes from the outer circumferential surface of the outer race 51 and a protrusion locking groove (not shown is formed in the inner circumferential surface of the shaft hole 12a so as to seat the locking protrusion 51a therein, so that the unidirectional bearing is integrated with the sprocket shaft 12 by the engagement of the locking protrusion 51a with the protrusion locking groove and can be rotated together with the front sprocket unit 10.

Further, a locking slot 52a is formed in the inner circumferential surface of the inner race 52 and a locking key 11a protrudes from the drive shaft 11 so as to be inserted into the locking slot 52a, so that the inner race 52 can be rotated together with the drive shaft 11 of the pedals 2 by the engagement of the locking key 11a with the locking slot 52a.

The outer race checking unit 54 includes: roller strop protrusions 54a that protrude from the outer circumferential surface of the inner race 52 at spaced locations and stop the respective rollers 53 in a direction opposite to the forward rotating direction which tends to propel the bicycle body 1 forwards,

checking pins 54b that are movably connected to the respective roller stop protrusions 54a and push the rollers 53 in the forward rotating direction which tends to propel the bicycle body 1 forwards, and

springs 54c that are placed in the roller stop protrusions 54a and elastically bias the respective checking pins 54b.

When the inner race 52 is rotated in the forward rotating direction that is the clockwise direction which tends to propel the bicycle body 1 forwards, the rollers 53 move to respective narrow spaces and are wedged between the outer race 51 and the inner race 52, thereby causing the outer race 51 to be rotated together with the inner race 52.

When the inner race 52 is rotated in a direction opposite to the forward rotating direction which tends to propel the bicycle body 1 forwards, the rollers 53 move to respective wide spaces and isolate the outer race 51 from the inner race 52 so that the rotating force of the inner race 52 is not transmitted to the outer race 51 and the inner race 52 overruns with the outer race 51 not rotating.

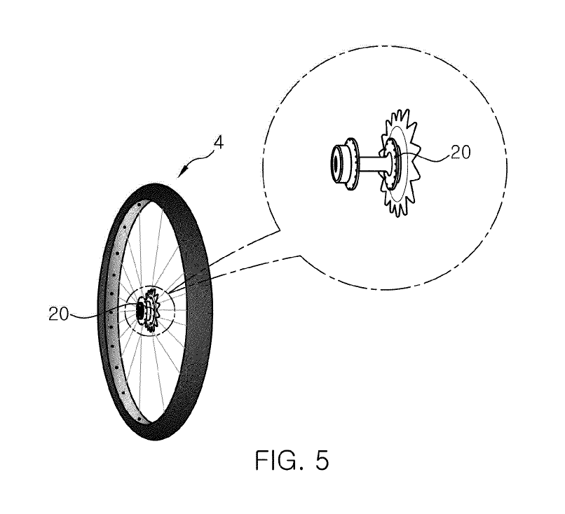

Further, as shown in FIG. 5, the rear sprocket unit 20 of the present invention is mounted to the rear wheel 4 of the bicycle body 1 so that the rear sprocket unit 20 can be rotated together with the rear wheel 4.

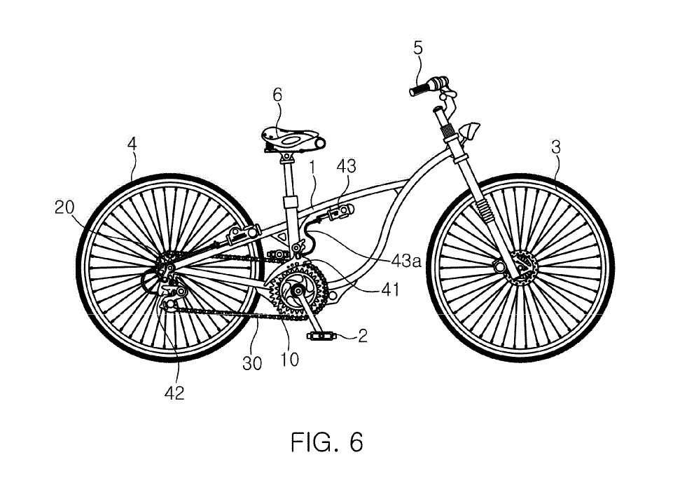

As shown in FIG. 6, the bicycle includes a front wheel 3 and the rear wheel 4 that are rotatably mounted to the front part and the rear part of the bicycle body 1, a handlebar 5 that is mounted to the front part of the bicycle body 1 and allows the rider to steer the front wheel 3 while holding the handlebar 5 with hands, a seat 6 that is mounted to the upper part of the bicycle body 1 and allows the rider to sit thereon, and the pedals 2 that are provided below the seat 6 and produce a rotating force when the rider works the pedals with the feet. When the rider sitting on the seat 6 works the pedals 2 with the feet, the rotating force of the pedals is transmitted to the rear wheel 4 by the automatic transmission of the present invention, thereby rotating the rear wheel 4 and moving the bicycle forwards.

The front derailleur 41 and the rear derailleur 42 are operated according to riding conditions of the bicycle, such as the moving speed of the bicycle and the gradient of a road, while riding the bicycle and shift the drive chain 30 to sprockets having different diameters, thereby performing an automatic gear-shifting operation.

In the above state, even when the rider does not work the pedals 2, the rear sprocket unit 20 is rotated together with the rear wheel 4 so that the drive chain 30 can be precisely shifted to desired sprockets, thereby realizing a desired gear-shifting stage.

Further, when the rider does not work the pedals 2, the inner race 52 is brought into a state that is equal to the state in which a rotating force, the direction of which is opposite to the forward rotating direction that tends to propel the bicycle forwards, is applied to the inner race 52. In the above state, the outer race 51 is rotated separately from the inner race 52 because the outer race 51 may receive a rotating force of the rear wheel 4 or may be still under the influence of the inertial force that was produced when the rider worked the pedals 2, so that the front sprocket unit 10 rotates in synchro with the outer race.

Therefore, even when the rider does not work the pedals 2 while riding the bicycle, the front sprocket unit 10 can be rotated by the rotating force of the rear wheel 4. Further when performing a gear-shifting operation, the drive chain 30 is precisely shifted to the desired sprockets, thereby realizing a desired gear-shifting stage.

As described above, the present invention is advantageous in that even when the rider does not work the pedals 2 while riding the bicycle, both the front sprocket unit 10 and the rear sprocket unit 20 are rotated so that the drive chain 30 can be efficiently shifted to desired sprockets and can be precisely wound around the sprockets. Therefore, the present invention can prevent the drive chain from being removed from the sprockets and prevent safety accidents from occurring even when the rider does not work the pedals 2 of the bicycle while performing the gear-shifting operation.

Particularly, when the automatic gear-shifting operation is performed according to a variation in the riding conditions, the rider may not acknowledge the gear-shifting operation and, accordingly, may not work the pedals 2. However, the present invention can efficiently and precisely perform the automatic gear-shifting operation even when the rider does not work the pedals 2, thereby allowing the rider to more easily and efficiently manipulate the transmission and ensuring safety of the rider when performing the gear-shifting operation of the bicycle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An automatic transmission for a bicycle, comprising:
a front sprocket unit coupled to a drive shaft of pedals of a bicycle body and rotating by a rotating force of the pedals, the front sprocket unit being formed by assembling a plurality of sprockets having different diameters;
a rear sprocket unit mounted to a rear wheel of the bicycle body and formed by assembling a plurality of sprockets having different diameters;
a drive chain, extremities of which are wound around one sprocket of the front sprocket unit and one sprocket of the rear sprocket unit, respectively; and
a drive chain shifter shifting one of the extremities of the drive chain to one sprocket of the front sprocket unit so as to allow the one extremity of the chain to be wound around the sprocket of the front sprocket unit and shifting the other extremity of the drive chain to one of the rear sprocket unit so as to allow the other extremity of the chain to be wound around the sprocket of the rear sprocket unit,
wherein the front sprocket unit is coupled to the drive shaft of the pedals in such a way that the front sprocket unit can rotate by a rotating force of the pedals when the pedals rotate in a rotating direction which propels the bicycle body forwards, but the drive shaft of the pedals can overrun when the pedals rotate in a direction opposite to the rotating direction.

2. The automatic transmission for the bicycle as set forth in claim 1, wherein the drive chain shifter comprises:
a front derailleur shifting the one extremity of the drive chain to one sprocket of the front sprocket unit so as to allow the extremity of the chain to be wound around the sprocket of the front sprocket unit;
a rear derailleur shifting the other extremity of the drive chain to one sprocket of the rear sprocket unit so as to allow the extremity of the chain to be wound around the sprocket of the rear sprocket unit;
a derailleur actuator actuating the front derailleur and the rear derailleur; and
a derailleur controller controlling an operation of the derailleur actuator so as to realize an appropriate transmission gear ratio suitable to riding conditions of the bicycle.

3. The automatic transmission for the bicycle as set forth in claim 1, wherein the drive chain shifter comprises:
a speed sensor for sensing a speed of the bicycle and an angle sensor for sensing a gradient of a road.

4. The automatic transmission for the bicycle as set forth in claim 3, wherein the drive chain shifter further comprises:
a position sensor for sensing a position of the drive chain and applying sensing results to the derailleur controller.

5. The automatic transmission for the bicycle as set forth in claim 2, wherein the derailleur actuator comprises:
an actuating cable connected to the front derailleur and the rear derailleur;
a rack gear connected to the actuating cable;
a pinion gear rotatably engaged with the rack gear; and
a worm engaged with the pinion gear and rotating in opposite directions by a motor.

6. The automatic transmission for the bicycle as set forth in claim 1, wherein the front sprocket unit comprises the drive shaft connected to the pedals and a shaft hole receiving the drive shaft therein, the transmission further comprising:
a unidirectional bearing interposed between the drive shaft and the shaft hole so that the unidirectional bearing can allow the front sprocket unit to rotate synchro with the pedals when the pedals rotate in the rotating direction propelling the bicycle body forwards, but does not transmit the rotating force of the pedals to the front sprocket unit when the pedals rotate in the direction opposite to the rotating direction, wherein the unidirectional bearing comprises:
an outer race integrated with the front sprocket unit;
an inner race integrated with the drive shaft of the pedals;
rollers placed between the outer race and the inner race; and
an outer race checking unit that allows the outer race to rotate synchro with the inner race when the inner race rotates in a rotating direction which propels the bicycle body forwards, and allows the inner race to overrun with the outer race which does not rotate when the inner race rotates in a direction opposite to the rotating direction.

7. The automatic transmission for the bicycle as set forth in claim 6, wherein the outer race checking unit comprises:
roller stop protrusions protruding from an outer circumferential surface of the inner race at spaced locations and stopping the respective rollers in the direction opposite to the rotating direction which propels the bicycle body forwards;
checking pins movably connected to the respective roller stop protrusions and pushing the respective rollers in the rotating direction which propels the bicycle body forwards; and
springs placed in the respective roller stop protrusions and elastically biasing the respective checking pins.

8. The automatic transmission for the bicycle as set forth in claim 1, wherein the rear sprocket unit is coupled to the rear wheel of the bicycle in such a way that the rear sprocket unit can rotate synchro with the rear wheel of the bicycle.
